(19) United States
(12) Patent Application Publication
(10) Pub. No.: US 2002/0035482 A1
(43) Pub. Date: Mar. 21, 2002

(54) Business to business information environment with subscriber-publisher model

(76) Inventors: Keith A. Coble, Camarillo, CA (US); Christopher M. Predcek, Klamath Falls, OR (US); Jim N. Long, Chiloquin, OR (US); Calvin Keith Caldwell, Chiloquin, OR (US); Michael Richard Penta, San Francisco, CA (US); Jeffery Allen Morrison, Klamath Falls, OR (US)

Correspondence Address: KOPPEL & JACOBS, AN ASSOCIATION OF PROFESSIONAL LAW CORPORATIONS, SUITE 107, 555 ST. CHARLES DRIVE, THOUSAND OAKS, CA, 91360, US

(21) Appl. No.: 09/940,907

(22) Filed: Aug. 28, 2001

Related U.S. Application Data
(60) Provisional application No. 60/228,607, filed on Aug. 28, 2000.

(51) Int. Cl. G06F 17/60

(52) U.S. Cl. 705/1; 705/10

(57) ABSTRACT

The invention includes a data processing system, a method and a business method. The method links multiple parties: a “publisher”, a “Subscriber”, and an intermediary information exchange engine which facilitates information exchange between the publisher and the subscriber over a data network (typically the public network known as the “Internet”). Metadata is transferred from the publisher to the subscriber, via the intermediary by application of a schema transform applied in software run by the intermediary. Normalized data is transferred substantially without modification from the publisher to the subscriber, provided that the intermediary is able to verify that the subscriber has been previously authorized to receive the particular data. Subscriber status is specified for each distinct type of data, by previous consensus of the first and second parties. Denormalized data is transferred between the publisher and the subscribers, via the intermediary, according to an equivalence transformation applied by the intermediary. First, subscriber status with respect to a particular set of data is verified by the intermediary for the requesting subscriber. Next, denormalized information from a publisher is processed by the intermediary in a transform mapping program, and a provisional equivalence is proposed by the program. The provisional equivalence is sent to the subscriber for verification.

This application claims priority of Provisional Application Ser. No. 60/228,607, filed on Aug. 28, 2000.

### BACKGROUND OF THE INVENTION

1. Field of the Invention

This invention relates to data networks generally and more specifically to business-to-business information exchange over a wide-area, public network such as the Internet.

2. Description of the Related Art

With the exponential growth of e-commerce, business-to-business information interchange, e-communities, and high level networking technologies, the management of information coherency, correlation, and redundancy is becoming increasingly difficult. The number and size of individual information items and information domains is also growing exponentially. Consequently, without new solutions, the cost of managing data coherency, correlation and redundancy within, between, and across information domains will grow exponentially as this trend continues. Moreover, the complexity of inter-domain information structures will grow even faster as enterprises abandon traditional one-to-one topologies in favor of many-to-many topologies, electronically linked business communities. Examples of complex electronically linked business information exchange problems include the merger of multiple companies over time with separate, but equal, business information systems coupled with the need to preserve all systems separately but allow them cooperate and share data.

Another problem is that of “outsourced” services whereby companies with separate, but dissimilar, business information systems need to exchange information in a collaborative fashion. Portions of the collaborative information domain include information that remains constant for all domain participants as well as data that is shared and is equivalent (but not identical) between domains.

Cross-domain e-community information interchange must accommodate cross-domain linkages that are private and privileged requiring consent of one or more parties prior to information flow. Current solutions address only half of the cross-domain information interchange problem. Specifically they address cross-schema mappings, and data transforms based on specific algorithms. A greater problem exists in the context of information that is shared between domains where there is a need to reference common data elements that are equivalent, but not identical, as viewed in the context of an e-community.

An example of this type of problem can be found in customer relationship management. A manufacturer may outsource its sales and marketing functions to two independent companies. This collection of three independent business entities comprises an e-community. The collective customer serviced by the e-community members in this example may be referred to as Agilent in the manufacturer's information domain, HP in the outsourced sales company, and Hewlett Packard in the outsourced marketing company. Yet each of these e-community members must share and collaborate within the context of a common customer frame of reference across the boundaries of their independent information domains.

In the current Internet based information system environment, the problem of information coherency and redundancy is two-fold. Since the Internet has become a fast and efficient transport for information exchange, the amount of information available from this resource has been growing rapidly. The ease and speed of collecting and disseminating information in an Internet based environment causes faulty data to become stored and propagated. Similarly, several variants of good data are often redundantly distributed, taking up valuable storage and bandwidth resources. The question proving the most difficult to answer is, “What data is the good data”

Historically, this problem was manageable. In legacy data environments, data was centrally located, allowing problems to be resolved at the database level. As shown in FIG. 1, terminals 10 were hung off of a mainframe computer 12 to allow multi-user creation, retrieval, editing, and deletion of information. The database 13 enforced rules attempting to avoid data redundancy and incoherence.

As information content grew over time, so did database systems. Database systems went from single database points of contact to networks consisting of multiple database management systems (DBMS) environments spread over large physical distances. Even with a large, physically remote DBMS, the problems of data redundancy and coherency could be solved through the enforcement of DB schema rules and the use of replication.

As soon as the problem of enterprise data moved outside the corporate bubble and into public networks, such as an Internet based information-sharing environment, the solution difficulty increased. The first problem is information representation itself. In the business-to-business environment (illustrated in FIG. 2) corporations need to agree upon not only what information is going to be exchanged, but what formats will be interchanged and how conflicts between data representation will be resolved. In FIG. 2, Corporation A (shown generally at 14) and Corporation B (shown generally at 16) communicate by data transfer over a public network such as the Internet 18. To manage the data exchange, they need to agree what pieces of Data A and Data B will have global representation in the overall information system represented. This problem is easy to solve. It involves lawyers, paper, and signed agreements as well as some form of schema mapping and some insistent DBAs.

The second problem introduced by Internet based business to business data sharing is not so easy to solve. The data redundancy problem can be solved by protocol and agreed upon business alliances. The problem of data coherency requires more thought. What is shown in FIG. 2 is not a truly distributed information system since there is no global form of data. As soon as Corporation A and Corporation B enter into a strategic alliance requiring sharing of data, the system becomes distributed. In a distributed system there is an absence of global state that can be instantaneously detected by any of the consumers of the information of which the state is representative. So, as soon as the lawyers make the agreement and the database administrators (DBAs) implement the new database constructs, the information system depicted in FIG. 2 becomes incoherent.

### SUMMARY OF THE INVENTION

The invention includes a data processing system, a method and a business method. The method functions in the context of multiple parties or entities: a first party or “publisher” (which may be a large organization or business entity), a second party or “Subscriber” (which also might be a large organization or business entity), and a third party intermediary information exchange engine which facilitates information exchange between the publisher and the subscriber over a data network (typically the public network known as the “Internet”).

In the method of the invention, the intermediary information exchange engine facilitates data transfer between the publisher and the subscriber, preferably via a wide area data network such as the Internet. The publisher has data in its system which may include metadata, normalized data, and denormalized data. “Normalized data” refers to data which is in either a universally understood format or a format which is exactly known to the subscriber. “Denormalized data” refers to other data, which may be formatted differently or be differently represented in the subscriber's data structure.

In the invention, metadata is transferred from the publisher to the subscriber, via the intermediary by application of a schema transform applied in software run by the intermediary. Normalized data is transferred substantially without modification from the publisher to the subscriber, provided that the intermediary is able to verify that the subscriber has been previously authorized to receive the particular data. Subscriber status is specified for each distinct type of data, by previous consensus of the first and second parties.

Denormalized data is transferred between the publisher and the subscriber parties, via the intermediary, according to an equivalence transformation applied by the intermediary. First, subscriber status with respect to a particular set of data is verified by the intermediary for the requesting subscriber. Next, denormalized information from a publisher is processed by the intermediary in a transform mapping program, and a provisional equivalence is proposed by the program. The provisional equivalence is sent to the subscriber for verification. If the equivalence is accepted, a data token is passed back to the intermediary.

Optionally, once a data equivalence map is verified, an inverse mapping can be proposed which will allow publication in the opposite direction: from the subscriber to the original publisher. Thus, when data is authorized for publication in the inverse direction (from original subscriber to original publisher), a provisional inverse equivalence is proposed to the original publisher (now a subscriber). If the provisional equivalence relation is accepted by the original publisher (now subscriber), a token is passed back to the intermediary and the inverse mapping is established for future use.

The transform mapping program (and the inverse mapping program) preferably uses a many-to-many correspondence matrix to map denormalized data from the publisher's domain into the subscriber's domain (and optionally in the inverse direction as well).

Thus, the intermediary provides multiple services to subscribers and publishers. First, the intermediary provides a security screen by providing a secure processing area for data, which is not fully accessible to all subscribers. Preferably, the data is published to the intermediary in encrypted form, and remains encrypted until decrypted by the subscriber. Second, the intermediary allows the publisher to control access to information by authorizing subscribers for access to preidentified data types. Third, the intermediary keeps records of data transfer, which allows for audit. This can be used to charge for data access, to track access history, for market information, or for many other purposes.

In one business model, the intermediary contracts with subscribers and is compensated by the subscribers for providing the service of transferring the data from publishers, as described in the specification more fully below. The intermediary agrees to provide data transfer and transformation services to the publishers and subscribers in accordance with pre-defined security provisions, publisher/subscriber relationships and other control parameters. This service is particularly useful in a business-to-business environment, for example, for a manufacturer who provides product and sales related information to representatives and distributors.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a block diagram of a prior art, centralized information management system for business;

FIG. 2 is a block diagram of a conventional business to business information environment using a public network for data transfer;

FIG. 3 is a flow chart showing the steps of a method in accordance with the invention;

FIG. 4 is a block diagram showing component relations between a publisher, a subscriber, and an information integration engine in accordance with the invention;

FIG. 5 is a state transition diagram generally in UML form, showing more detailed method steps for initializing a publication/subscription interaction in accordance with the method of the invention; and

FIG. 6 is a state transition diagram generally in UML form, showing more detailed method steps for completing the publish/subscribe interactions in accordance with the method of the invention.

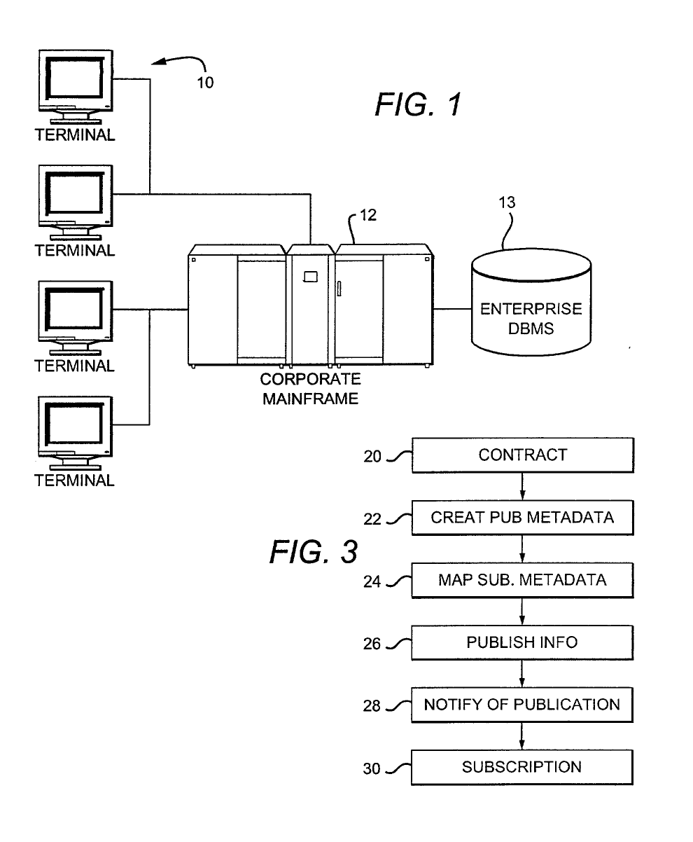

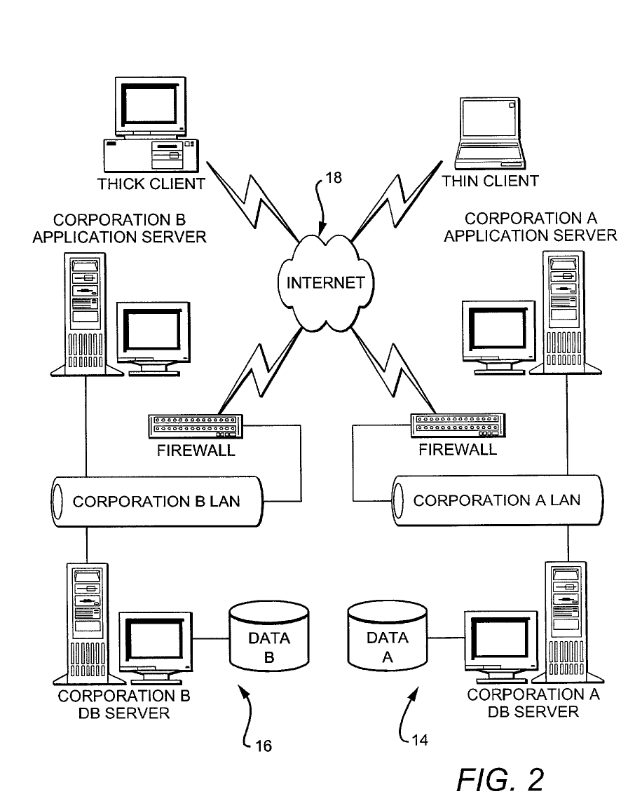

### DETAILED DESCRIPTION OF THE INVENTION

Glossary:

The following definitions are offered for convenience to aid in understanding the description, but are not intended to be limiting. None of the definitions are intended to contradict any normal usage of the terms.

Information Domain—The sum of all information sources relevant to a company or business. An information source can be anything from an email system to a network of relational databases, without limitation.

Metadata—Data that describes the format and content of other data (e.g. a database schema).

Publisher—An entity that has ownership of an information set that will be shared among several other entities. The information set is presented with an Information Integration Engine acting as an intermediary.

Publication—A contract for posting of information with the Information Integration Engine. This contract is composed of permissions related to what subscribers can see the information, what parts of the information each subscriber can see, and the metadata description of the information being published.

Subscriber—An entity that will consume information served up by a publisher.

Subscription—A contract for receipt of a publication comprised of permissions related to information the subscriber is allowed to see and the information transformation required to map the publisher information into the subscriber information domain. The contract is managed through the intermediary Information Integration Engine.

Transformation—A set of logical operations that will move a piece of information from one information domain to another information domain.

Introduction

The invention includes a data processing system implementing a business method, a data processing engine, and a data transport process. The invention is capable of mapping heterogeneous data sources for effective sharing of strategic information between a plurality of different, cooperating businesses, communicating through a public (or private) data network.

FIG. 3 shows the steps in a data processing method in accordance with the invention. The method includes a sequence of steps, as follows:

Contract Establishment (step 20)—An information producer business (the publisher) enters into a contract with an information consumer business (the subscriber). The contract details what information will be shared from the publisher to the subscriber (one-way).

Publication Metadata Creation (step 22)—The publisher creates an information schema. The information schema describes the information to be published. This schema is transferred via a data network to the Information Integration Engine as the publication metadata.

Subscription Metadata Mapping (step 24)—The subscriber retrieves the publication schema from the Information Integration Engine, via the data network. From the publication metadata, the subscriber will create a transformation that, when logically applied to the publication, maps the published information to an information set useful to the subscriber. The scope of subscription is limited by the established contract. The subscription map is managed by Escend Information Integration Engine.

Information Publication (step 26)—The publisher applies the publication metadata to their information repository. The Information Integration Engine extracts information from the publisher information domain and places it into a shared information domain. The shared information domain is accessible only to the subscribers with an appropriate established contract.

Publication Notification (step 28)—All subscribers to the publication will be notified, via the data network, of publication availability when the publisher publishes an information set. The Information Integration Engine performs the notification. Preferably, the a publication is parsed before publication, so that individual fields from a larger data block are published to various subscribers in accordance with publication constraints which link individual data fields to individual subscribers. Thus, within a larger publication block there may be smaller fields identified so that some subscribers may receive certain fields which may comprise less than the entire publication block.

Information Subscription (step 30)—Upon receipt of the publication notification, the subscriber contacts the Information Integration Engine to retrieve their subscription via the data network. The Information Integration Engine uses the subscriber metadata map to transform the retrieved information from the publisher information domain to the subscriber information domain.

The Information Integration Engine acts as an “information domain link repository” for many-to-many relationships between information domains of user businesses. The use of a metadata processing engine along with a transformation mapping component, gives companies residing in a heterogeneous information environment the ability to effectively share data across a wide area network such as the “Internet”.

The invention's Information Integration Engine draws on three main areas. These are the areas of networking theory, database theory, and set theory. The application of any single of these theoretical areas proves provides no new material into the problem solution set for this problem domain of n to n heterogeneous information exchange. However, when the three areas are combined in a single solution, the result is a powerful Information Integration Engine that solves the logical relationship combinatorial explosion, the transformation script combinatorial explosion, and the informational integrity resulting from spontaneous loss or creation of data.

Networking Theory Application

Networking theory is involved in the physical connectivity of the Information Integration Engine with the publisher and subscriber entities. The resulting network represents a star topology in which the Information Integration Engine is the centralized node. Also, networking theory has application in the use of the publish/subscribe paradigm. Publish/subscribe is used to control the sequence of events involved in the sharing of information.

Database Theory Application

Database theory is involved in the resolution of the “n” to “n” connectivity relationship between information sharing entities. In effect, the Information Integration Engine repository provides a “link” repository for two information entities wishing to share content. This is a standard database idea raised to an enterprise level. Rather than providing a link between “n” rows of two tables in a database, Information Integration Engine provides a link between “n” databases of two information domains in a global information environment. Using Information Integration Engine as an intermediary, the number of logical connection for a n to n domain mapping reduce from (n) (n−1) to 2 n. Also, the number of required transformations reduce from (n) (n−1) to n since a transformation is only defined for each subscriber.

Set Theory Application

Set theory is involved in the mapping of information from one information domain to another information domain. The use of a linear transformation allows information to be mapped from information domain A to information domain B such that an inverse transformation is possible. By definition, this mapping neither creates or destroys information. This property allows the publisher to define an information publication that will map the publisher information domain into the Information Integration Engine repository. Then the subscriber can define an information subscription that will transform the published information domain into the subscribers information domain. With each mapping, there is an optional inverse mapping possible.

Information Integration Engine Component Relations

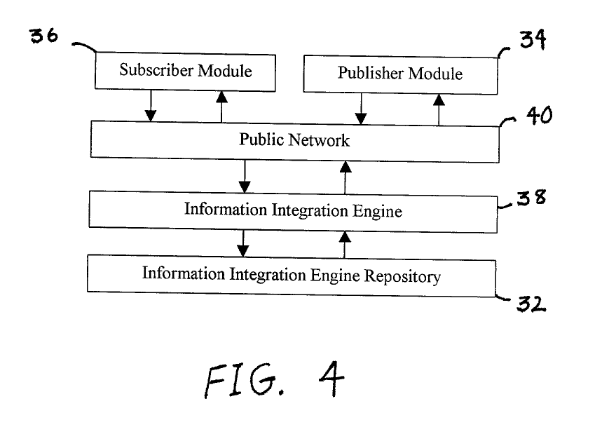

The predictable sharing of information requires the definition of an information sharing business process. Each stage of this process requires a piece of the Information Integration Engine. The Information Integration Engine acts as process control as well as providing the services to allow information sharing between two heterogeneous information domains. The component relationships between the subscriber module (“subscriber plug-in”), the publisher module (“publisher plug-in”) and the Information Integration Engine are shown in FIG. 4.

Information Integration Engine Repository (32)

The Information Integration Engine Repository 32 provides persistent storage for publisher schema definitions, published information based on the publisher schema definition, subscriber schema definitions and subscriber information transformations. The Information Integration Engine Repository 32 also provides logic allowing a publisher and subscriber to correctly exchange information in a secure and controlled environment.

Publisher Module (34)

The Publisher Module 34 provides the publisher with tools to help in the definition of a publication as well as the capabilities to communicate the publication schema and subscriber constraints with the Information Integration Engine Repository 32. The Publisher Module 34 is used to define an information publication and perform the actual information publication. Optionally, the publisher plug in 34 also encrypts the publication information before transmission to the intermediary, in a form known to the intermediary and the publisher.

Subscriber Module (36)

The Subscriber Module 36 provides the subscriber with tools to aid in the definition of the transformation to transform published information from the publisher information domain to the subscriber information domain. The Subscriber Module 36 is also performs the actual information subscription so when a publication notification is received, the subscriber can go to the Information Integration Engine repository 32 to start the publication process. The Subscriber then acts as an intermediary between the newly received subscription and the conflict resolution engine. Optionally, the subscriber module also decrypts information which it receives from the intermediary information integration engine in encrypted form.

Conflict Resolution Engine (38)

After performing a subscription to a publication, the subscriber will receive a set of data that has been mapped into their information domain. This data can potentially contain records that are duplicates of existing information in the subscriber information domain. For example, the subscriber may have a Customer record that contains a slight variant of the email address. The conflict resolution engine 38 will detect this duplication and provide the subscriber with a mechanism for resolving such conflicts.

Process and Information Integration Engine Application

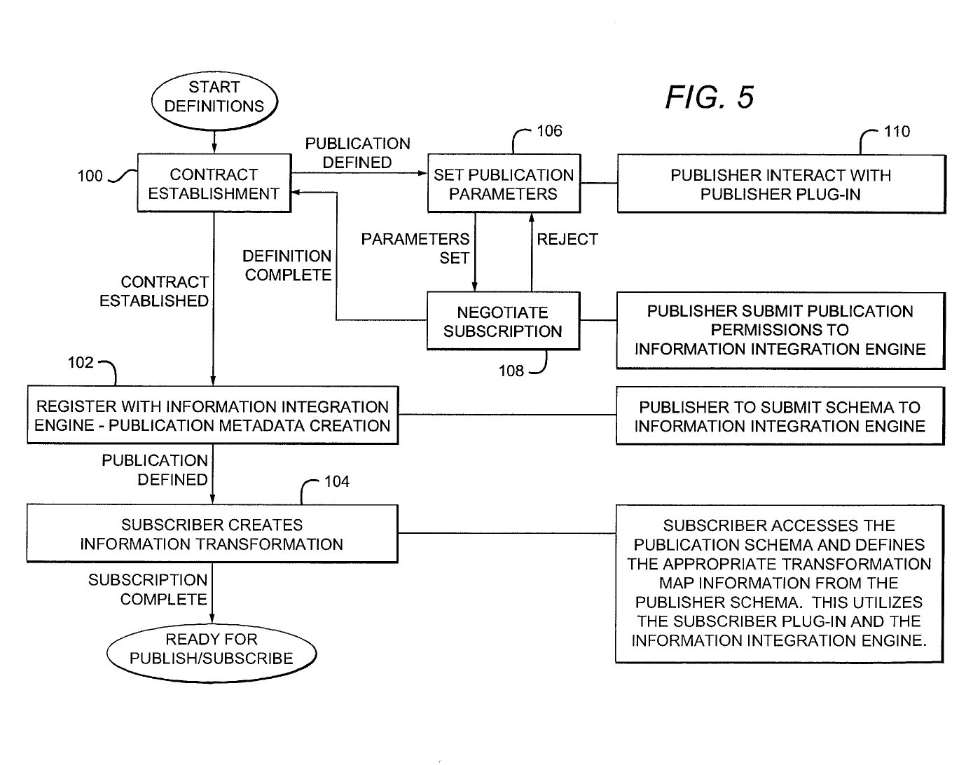

As was mentioned in the introduction, the Information Integration Engine not only provides the mechanism required to safely share data between two heterogeneous information domains, but it also enforces a business process to be used for effective information sharing. FIG. 5 details a state transition diagram showing the process steps for initializing the publication/subscription interaction and Information Integration Engine application.

Contract Establishment 100

An information publisher and information subscriber enter into a contract describing the information that will be shared between the two entities. The outcome of this contract is a description of the information that the publisher will be sharing with the subscriber. This step involves setting up permissions on the publisher side indicating that the subscriber will allowed to obtain access to the publisher publications through the Information Integration Engine Repository.

In step 100a the publication parameters are set by publisher interaction with the publisher plug in. Next, a subscription is negotiated in step 100b, in which the publisher submits publication permissions via the Information integration Engine. When the parameters have been agreed upon, the definition is complete and the contract is established, completing step 100.

Publication Metadata Creation 102

After the contract is established, the publisher will define the metadata that describes what information will be extracted from their information domain and placed in the Information Integration Engine Repository for use by the subscriber. The Publication metadata will describe the organization, type, and format (collectively, the “schema”) of the data to be published. Publication metadata creation involves the use of the Publisher Module and the Information Integration Engine Repository for storage of the publisher metadata description.

Subscription Metadata Mapping (Transformation Definition) 104

When the publication metadata is available, the subscriber will define the information transformation that will be applied to the publisher's information publication schema. This transformation will be used to move the published information from the publisher's information domain into the subscriber's information domain. The Subscriber Module is used to aid in transformation definition as well as send the defined transformation to the Information Integration Engine repository for use when the actual subscription takes place.

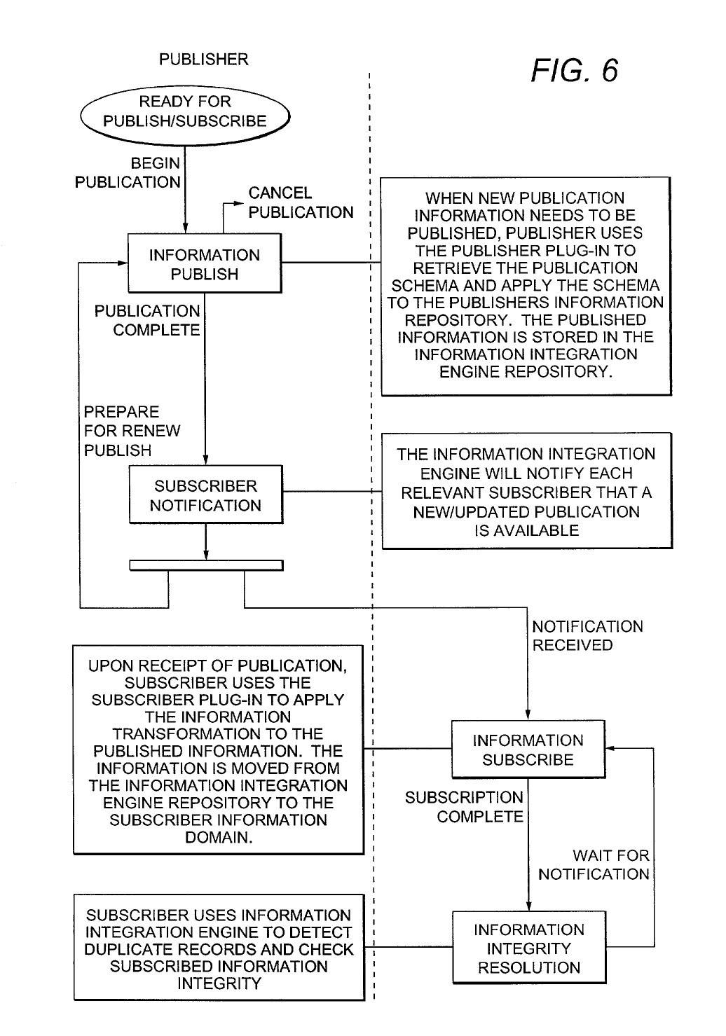

FIG. 6 shows the publish/subscribe cycle and application of Information Integration Engine.

Information Publication 120

The publisher uses the Publication Module to access the publishers information source and apply the publication metadata to move the correct information from the publishers information domain to the Information Integration Engine Repository. Upon receipt of a new publication from the publisher, Information Integration Engine will notify the subscriber that a new information publication is available.

During publication 120, when new publication information needs to be published, the publisher uses the publisher module to retrieve the publication schema and apply the schema to the Publisher's information repository. The published information is stored in the information integration engine repository.

Since a publication can contain information that has links to other information in the publication information domain, rules apply to the information represented in the publication. Such an arrangement is analogous relationships in a relational database. In a table contained in a relational database, a reference to a second table is represented by a foreign key that references the primary key of the referenced table. This condition can be present in the information domain of the publisher where the reference is between two information elements. With such a condition, a decision must be made to determine what information, if any, should be published. The Information Integration Engine handles this condition by publishing all information defined in the publication metadata. If the publication metadata defines a link in a publication, the reference will be published based on the rules:

1. If the information described by the link exist in the publisher information domain, the referenced information will also be published, thus the published link will reference valid information.

2. If the information described by the link does not exist in the information domain yet the reference and referenced information metadata has been defined in the publication metadata, the link will be published as a null place holder where there is no valid referenced information available.

3. No reference will be published unless the referenced information element has also been defined in the publication metadata.

Publication Notification 122

As mentioned above, when a publisher publishes new information to the Information Integration Engine Repository, the Information Integration Engine Repository will notify all subscribers that have a valid contract with the publisher for the specific publication being made. The constraints set during contract establishment 100 are strictly enforced by the information integration engine at this and all further steps.

Information Subscription 124

After receiving the publication notification, the subscriber will use the Subscriber Module to access the published information and apply ae transformation from the publisher's schema into a schema defined by the subscriber. The published information will be transformed and moved from the Information Integration Engine Repository to the subscriber information domain. After the information is transformed and moved, the information will be cleaned and checked for validity and duplication (step 126, information integrity resolution).

Optionally, information published to the subscriber from the information integration engine is transferred in encrypted form known to the subscriber and the information integration engine. The encryption technique need not be known to the publisher or to other subscribers, however, and in generally will not be so globally known for security reasons.

System Requirements

The Publisher module is preferably implemented by a software program running on a general purpose computer with access to a public data network. The following system is adequate for implementing the engine, by way of example, but is not intended to limit the possible hardware and software environment of the invention in any way:

Processor: Pentium II microprocessor with 128 Megabytes RAM and an Internet connection, preferably cable modem or faster.

Software: Windows NT 4.0+/2000 server or equivalent SQL Server 7.0+ or equivalent

Internet Explorer/Netscape or equivalent

Publisher module software program

The information integration engine is preferably implemented is preferably implemented by a software program running on a general purpose computer with access to a public data network. The following system is adequate for implementing the engine, by way of example, but is not intended to limit the possible hardware and software environment of the invention in any way:

Processor: Dual Pentium III microprocessors with high speed Internet access and a Web Server application specific provider.

Software: Windows 2000 advanced Server or equivalent; SQL Server 2000 or equivalent; Internet explorer/netscape or equivalent.

Subscriber module: is preferably implemented by a software program running on a general purpose computer with access to a public data network. The following system is adequate for implementing the engine, by way of example, but is not intended to limit the possible hardware and software environment of the invention in any way:

Same or similar to that required for the Publisher Module, described above.

Conclusion

Through the use of three different theories and application of those ideas through a software system, Information Integration Engine provides a unified and centralized information exchange engine. This engine reduces the complexity of information exchange networks as well as reduces the software complexity required to implement a “n” by “n” information exchange between enterprise scale information systems.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

I claim:

1. A method of facilitating data transfer between a first party (“publisher”) and a second party (“subscriber”) via a wide area data network such as the Internet, suitable for exchanging data which is stored in different formats by the subscriber and publisher, comprising the steps of:
causing the transfer of a data package from the publisher to an intermediary information exchange engine via the data network in a format defined by the publisher;
consulting a database to determine subscriber status with respect to said data package;
determining whether said data package is normalized or denormalized data;
if said data package is denormalized, processing said information with a transform mapping program to produce a provisional equivalence transformation which maps said data into a form defined by the subscriber;
transmitting the provisional equivalence transformation to the subscriber for verification;
conditioned upon verification by said subscriber, transmitting a transformed data package to the subscriber in said form defined by the subscriber.

2. The method of claim 1, wherein said transform mapping program uses a many-to-many correspondence matrix to map denormalized data from the form defined by the publisher into the form defined by the subscriber.

3. The method of claim 1, wherein said data package is transferred from the publisher to the intermediary over a public network in a encrypted form.

4. The method of claim 3, wherein said transformed data package is transmitted from the intermediary to the subscriber over a public network in an encrypted form.

5. The method of claim 1, further comprising the step of making a record of said data transfer, wherein said act of making a record is performed by said intermediary information exchange engine.

6. The method of claim 1, further comprising the steps of:
transferring from the subscriber to the intermediary a second data package;
determining whether said second data package is normalized or denormalized data;
if said second data package is denormalized, processing said information with an inverse transform mapping program to produce an inverse provisional equivalence transformation which maps said data package into a form defined by the publisher;
transmitting the inverse provisional equivalence transformation to the publisher for verification;
conditioned upon verification by the publisher, transmitting an inversely transformed data package to the publisher in said form defined by the publisher.

7. A distributed data processing system for facilitating information exchange between commercial business entities (parties), comprising:
a publisher module computer program which causes a publishing computer to define a publication, a publication schema and subscriber constraints and to transmit these over a public data network;
an information integration engine computer program executing on an intermediary computer system, which causes said intermediary computer system to receive said publication, said publication schema and said subscriber constraints via said data network;
wherein said information integration engine computer program further causes said intermediary computer system to communicate said publication to a subscriber only as permitted by said subscriber constraints; and
a subscriber module computer program which causes a subscriber computer to receive said publication from said intermediary computer system via the public data network;

8. The system of claim 7, wherein said information integration engine computer program further causes said intermediary computer to apply a schema transformation which maps said publication into a subscriber-defined schema;
and wherein said subscriber module computer program creates a subscription map which maps data from said publication schema to a subscriber defined schema, and communicates said subscription map to said intermediary via the public network.

9. The system of claim 8, wherein said publisher computer transmits said publication to the intermediary over the public network in encrypted form.

10. The system of claim 9, wherein said intermediary transmits said publication to said subscriber over a public network in an encrypted form.

11. The system of claim 7, wherein said intermediary information integration engine further causes said intermediary computer to create a record of a reception of said publication and the transmission of said publication to said subscriber.

12. The system of claim 7, wherein said intermediary information integration engine uses a many-to-many correspondence matrix to map denormalized data from the schema defined by the publisher into a form defined by the subscriber.

13. A computer program product comprising:
a first computer usable medium having computer readable program code embodied in said medium for causing a publishing computer to define a publication, a publication schema and subscriber constraints and to transmit these over a public data network;
a second computer usable medium having computer readable program code embodied in said medium for causing a second computer system to receive said publication, said publication schema and said subscriber constraints via the data network; and
a third computer usable medium having computer readable program code embodied in said medium for causing a subscriber computer to receive said publication from said second computer system via the public data network;
wherein said computer program code embodied in said third computer usable medium further causes said second computer system to communicate said publication to said subscriber computer only as permitted by said subscriber constraints.

14. The computer program product of claim 13, wherein said program code embodied in said second computer usable causes said intermediary computer to apply a schema transformation which maps said publication into a subscriber-defined schema;
and wherein said subscriber computer creates a subscription map which maps data from said publication schema to a subscriber defined schema, and communicates said subscription map to said second computer via the public network.
